(19) United States
(12) Patent Application Publication
(10) Pub. No.: US 2009/0136308 A1
(43) Pub. Date: May 28, 2009

(54) Rotary Burr Comprising Cemented Carbide

(75) Inventors: Alan Newitt, Whitestone (GB); David John Payne, Coalville (GB); X. Daniel Fang, Brentwood, TN (US); David J. Wills, Brentwood, TN (US)

Correspondence Address: ALLEGHENY TECHNOLOGIES INCORPORATED, 1000 SIX PPG PLACE, PITTSBURGH, PA, 15222-5479, US

(73) Assignee: TDY Industries, Inc., Pittsburgh, PA (US)

(21) Appl. No.: 11/945,372

(22) Filed: Nov. 27, 2007

(51) Int. Cl. B23B 27/20; B23B 27/22

(52) U.S. Cl. 408/145; 408/230; 407/56; 76/115

(57) ABSTRACT

A rotary burr comprising cemented carbide for removing material from a workpiece includes a shank and a working portion and a shank. A surface of the working portion includes a plurality of right-handed helically oriented flutes that define a plurality of cutting teeth on the working portion. Each of the plurality of cutting teeth defined by the right-handed flutes includes a front face, a back face, a tip, and a positive front face angle, and lacks a radial land adjacent the tooth tip and at the periphery of the working portion.

### BACKGROUND OF THE TECHNOLOGY

1. Field of Technology

The present disclosure relates to tools used for deburring and/or finishing articles. More particularly, the present disclosure relates to cemented carbide rotary burrs useful for removing material from articles composed of, for example, metals, metallic alloys, or certain non-metallic materials.

2. Description of the Background of the Technology

Rotary burrs formed from cemented carbide are known and are commonly used for abrading and smoothing metal and metallic alloy articles. Rotary burrs are available in various shapes, sizes, and abrasive textures, depending on the tool's intended application. Metals and metallic alloys may be welded, molded, cast, trimmed, slit, drilled, sheared, or machined, and these techniques often create ragged edges or small protrusions referred to as “burrs” on the metallic articles. The process by which the edges are finished and the protrusions are removed commonly is referred to as “de-burring” and may be performed using a rotary burr driven to rotate by a machine tool. In addition to de-burring, rotary burrs also have been used in techniques such as die sinking, pattern and tool making, and mold and small parts edge finishing.

Rotary burrs are similar to other rotary cutting tools in that all of these tools remove material from a workpiece. Rotary (i.e., rotationally driven) cutting tools, however, typically modify the functional geometry of the workpiece feature being machined. In contrast, rotary burrs are used for finishing operations that typically do not change the functional geometry of a feature that is being de-burred or otherwise finished.

The conventional process by which rotary burrs are manufactured is well known and includes consolidating in a mold a metallurgical powder blend including hard particles, which typically are or include transition metal carbide particles, and a powdered binder material to form a green compact. The green compact is then sintered at a temperature below the melting temperature of the powders to consolidate and metallurgically bind together the powder particles. The sintered compact is a cemented carbide tool blank having a generally homogenous, monolithic construction including a discontinuous phase of the hard particles embedded in a continuous phase of the binder. Subsequent to sintering, the tool blank may be appropriately ground and/or machined to include a series of helically oriented grooves or “flutes” on a working portion or “burr head” of the tool. The projecting regions defined between the flutes provide cutting teeth which are suitably machined to include a sharp cutting edge. Other features also may be ground or machined onto the tool blank to provide the desired tool geometry for the specific intended application.

As used herein, “cemented carbide” refers to the class of wear-resistant refractory materials including a discontinuous phase comprising hard carbide particles bound together, or cemented, by a continuous phase of ductile metal or metallic alloy binder material. A common cemented carbide material includes tungsten carbide particles embedded in a cobalt binder. However, as is known in the art, many possible particle and binder combinations exist, and particular combinations and concentrations of phases will be better suited for particular applications. Carbide particles conventionally used in cemented carbides include, for example, silicon carbide and carbides of certain transition metals of Groups IVB, VB and VIB of the periodic table, such as tungsten carbide (WC), titanium carbide (TiC), tantalum carbide (TaC), niobium carbide (NbC), and combinations of these. Examples of known binder materials conventionally used in cemented carbides include cobalt, cobalt alloy, nickel, and nickel alloy. Cemented carbides are well known to those having ordinary skill in the machining arts and, therefore, a more detailed discussion of such materials is unnecessary here.

The geometry (shape) of a rotary burr can be characterized by a number of functional features including flute depth, flute spacing, flute concentricity, helix angle, tooth profile, and tooth geometry. Until about the mid 1980's, most cemented carbide rotary burrs were ground using non-CNC technologies to provide the desired flute and tooth profiles. As CNC technologies were adapted to additional applications, grinding machines became available that could grind complex flute and tooth profiles in rotary burr blanks formed of cemented carbide. CNC-ground burrs offer consistent tolerances on the overall tool geometry and on the tooth profiles, allowing for finished and de-burred surfaces and edges having significantly improved quality.

There has been an accelerating demand from aerospace and other technology-intense industries for effective techniques to machine and finish metallic materials considered difficult to machine. Examples of difficult-to-machine materials include titanium and its alloys, certain alloys adapted for use in very high temperature environments, and certain exotic materials. These materials are increasingly being used in manufactured products, for example, in modern aircraft, which require lighter parts having increased strength and high heat resistance. Therefore, there exists an urgent and as-yet unsatisfied need to develop improved tools capable of efficiently and cost-effectively machining difficult-to-machine materials. In particular, a need has existed to develop rotary burrs that can more efficiently and cost-effectively de-burr and finish titanium and its alloys, and other difficult-to-machine materials. An objective of the present disclosure is to provide an improved cemented carbide rotary burr that may be used to more efficiently and cost-effectively de-burr and finish difficult-to-machine materials, as well as other metals, metallic alloys, and non-metallic materials.

### SUMMARY

According to one non-limiting aspect of the present disclosure, an embodiment of an improved rotary burr comprising cemented carbide includes a shank for attaching the rotary burr to a machine tool and a working portion. A surface of the working portion includes a plurality of right-handed helically oriented flutes that define a plurality of cutting teeth adapted for removing material from a workpiece. Each of the plurality of cutting teeth defined by the right-handed flutes includes a front face, a back face, and a tip, and has a positive front face angle (as defined hereinbelow). Each of the plurality of cutting teeth defined by the right-handed flutes also lacks a radial land adjacent the tooth tip at the periphery of the working portion. The inventors unexpectedly discovered that a rotary burr having this novel design provides significantly improved cutting performance and tool wear resistance, and allows for the machining of titanium, titanium alloys, and other difficult-to-machine alloys in a significantly more efficient and cost-effective manner.

According to certain non-limiting embodiments of a rotary burr comprising cemented carbide constructed according to the present disclosure, the rotary burr is constructed of a single cemented carbide material. According to certain other non-limiting embodiments, a rotary burr constructed according to the present disclosure includes at least a first region of a first material and a second region of a second material, wherein the first and second materials differ with respect to composition and/or at least one property. According to one such non-limiting embodiment, the first region comprises the working portion and the second region comprises the shank, and the shank is joined or otherwise connected to the working portion. In one particular non-limiting embodiment, the first material comprises cemented carbide, the second material comprises a metallic alloy such as, for example, a steel or a tungsten alloy, and the shank is joined to the working portion by brazing.

According to another non-limiting embodiment of a rotary burr comprising cemented carbide constructed according to the present disclosure, the rotary burr includes a first region comprising an outer region of the working portion, and a second region comprising both a core region of the working portion and the shank. In one particular non-limiting embodiment, the first material comprises a first cemented carbide, and the second material comprises a second cemented carbide. The first and second cemented carbides may differ in any desirable respect, such as in composition and/or with respect to at least one property. Examples of possible differences between the cemented carbides include differences in the identity or identities of hard particles and/or binders, or differences in the concentration of hard particles and/or binders.

According to another non-limiting embodiment of a rotary burr comprising cemented carbide constructed according to the present disclosure, the rotary burr includes a shank and a working portion. A surface of the working portion includes a plurality of right-handed helically oriented flutes, and further includes a plurality of left-handed helically oriented flutes. The left-handed flutes intersect the right-handed flutes on the surface of the working portion, producing a cross-hatched pattern that defines a plurality of discrete cutting teeth bordered by the right-handed and left-handed flutes. Each cutting tooth includes a front face, a back face, and a tip, and has a positive front face angle. Each cutting tooth also lacks a radial land adjacent the tooth tip at the periphery of the working portion.

According to yet another non-limiting embodiment of a rotary burr comprising cemented carbide constructed according to the present disclosure, the rotary burr includes a shank for attaching the rotary burr to a machine tool, and a working portion. The working portion includes at least an outer region of a first cemented carbide. A surface of the outer region includes a plurality of right-handed helically oriented flutes thereon, defining a plurality of cutting teeth. Each of the cutting teeth includes a front face, a back face, a tip, and a positive front face angle, and lacks a radial land at the periphery of the working portion. In certain non-limiting embodiments, the shank and at least a core region of the working portion comprise a second cemented carbide, which differs from the first cemented carbide. In certain other non-limiting embodiments, the working portion of the rotary burr includes the first cemented carbide, and the shank includes at least one of a steel, a tungsten alloy, or another metal alloy and is joined or otherwise connected to the working portion.

Certain non-limiting embodiments of a rotary burr comprising cemented carbide constructed according to the present disclosure may comprise a single-layer or multiple-layer surface coating on at least a region of the working portion of the rotary burr to enhance tool wear resistance and/or performance characteristics. Examples of possible surface coatings include chemical vapor deposition (CVD) coatings, physical vapor deposition (PVD) coatings, and diamond coatings.

According to yet a further aspect of the present disclosure, a method is provided for making an improved rotary burr comprising cemented carbide. The method includes providing a series of right-handed helically oriented flutes on at least a portion of the blank to provide a working portion of the rotary burr. Regions of the working portion disposed between adjacent flutes are machined to provide a series of cutting teeth on the working portion, wherein each cutting tooth includes a positive front face angle and lacks a radial land at a periphery of the working portion.

The reader will appreciate the foregoing details, as well as others, upon considering the following detailed description of certain non-limiting embodiments according to the present disclosure. The reader also may comprehend certain additional details upon carrying out or using the subject matter described herein.

### BRIEF DESCRIPTION OF THE DRAWINGS

Features and advantages of the subject matter described herein may be better understood by reference to the accompanying drawings in which:

FIG. 1 is a schematic cross-sectional view of one embodiment of a conventional cemented carbide rotary burr including teeth having a negative front face angle, wherein the cross-section is taken approximately mid-way along the length of the working portion of the rotary burr and at a right angle to the rotational axis of the tool;

FIGS. 2(a) and 2(b) are schematic cross-sectional views showing tooth profiles of embodiments of conventional cemented carbide rotary burrs;

FIG. 3 is a schematic cross-sectional view of another embodiment of a conventional cemented carbide rotary burr, wherein the cross-section is taken approximately mid-way along the length of the working portion of the rotary burr and at a right angle to the rotational axis of the tool;

FIG. 4 is a schematic cross-sectional view of yet another embodiment of a conventional cemented carbide rotary burr including teeth having a positive front face angle and radial lands about the periphery of the working portion, wherein the cross-section is taken approximately mid-way along the length of the working portion of the rotary burr and at a right angle to the rotational axis of the tool;

FIGS. 5(a) and 5(b), respectively, are photographs showing a cross-section through and a side elevation of the working portion of a commercially available cemented carbide rotary burr having a generally “tree-shaped” working portion;

FIGS. 6(a) and 6(b), respectively, are photographs showing a cross-section through and a side elevation of the working portion of another commercially available cemented carbide rotary burr having a generally “tree-shaped” working portion;

FIGS. 7(a) and 7(b), respectively, are photographs showing a cross-section through and a side elevation of the working portion of a commercially available cemented carbide rotary burr having a generally cylindrical working portion

FIGS. 8(a) and 8(b), respectively, are photographs showing a cross-section through and a side elevation of the working portion of another commercially available cemented carbide rotary burr having a generally cylindrical working portion;

FIG. 9 is a schematic cross-sectional view of an embodiment of a rotary burr constructed according to the present disclosure, including teeth having a positive front face angle and lacking radial lands at the periphery of the working portion, wherein the cross-section is taken approximately mid-way along the length of the working portion of the rotary burr and at a right angle to the rotational axis of the tool;

FIGS. 10(a) and 10(b), respectively, are a schematic elevational view and a schematic perspective view of another embodiment of a rotary burr constructed according to the present disclosure and having a generally cylindrical working portion;

FIG. 11(a) is a schematic cross-sectional view through the working portion of the rotary burr of FIGS. 10(a) and 10(b), and FIG. 11(b) shows, in magnified detail, circular portion B of the cross-section shown in FIG. 11(a);

FIGS. 12(a) and 12(b), respectively, are a schematic elevational view and a schematic perspective view of another embodiment of a rotary burr constructed according to the present disclosure and having a generally cylindrical working portion;

FIG. 13 shows several possible non-limiting examples of working portion configurations for rotary burrs constructed according to the present disclosure;

FIGS. 14(a) through 14(c) are schematic views of another non-limiting embodiment of a rotary burr constructed according to the present disclosure and having a generally cone-shaped working portion;

FIGS. 15(a) through 15(d) are schematic views of another non-limiting embodiment of a rotary burr constructed according to the present disclosure and having a generally cylindrical working portion including a cross-hatched tooth pattern formed by intersecting right-handed and left-handed flutes;

FIGS. 16(a) through 16(d) are schematic views of another non-limiting embodiment of a rotary burr constructed according to the present disclosure and including chip breaker structures spaced along the flutes of the generally cylindrical working portion;

FIGS. 17(a) through 17(d) are schematic views of two non-limiting embodiments of a rotary burr constructed according to the present disclosure, wherein the embodiments include regions of different materials;

FIGS. 18(a) and 18(b) are photographs of one non-limiting embodiment of a rotary burr constructed according to the present disclosure;

FIGS. 19(a) and 19(b) are photographs of another non-limiting embodiment of a rotary burr constructed according to the present disclosure; and

FIGS. 20(a) and 20(b) are graphs presenting test results comparing performance of an embodiment of a cemented carbide rotary burr constructed according to the present invention and commercially available cemented carbide rotary burrs.

### DETAILED DESCRIPTION OF CERTAIN NON-LIMITING EMBODIMENTS

In the present description of non-limiting embodiments and in the claims, other than in the operating examples or where otherwise indicated, all numbers expressing quantities or characteristics of ingredients and products, processing conditions, and the like are to be understood as being modified in all instances by the term “about”. Accordingly, unless indicated to the contrary, any numerical parameters set forth in the following description and the attached claims are approximations that may vary depending upon the desired properties one seeks to obtain in the subject matter described in the present disclosure. At the very least, and not as an attempt to limit the application of the doctrine of equivalents to the scope of the claims, each numerical parameter should at least be construed in light of the number of reported significant digits and by applying ordinary rounding techniques.

The present disclosure is directed to an improved design for a rotary burr comprising cemented carbide. As is known in the art, rotary burrs commonly comprise a hard metallic substrate that may be coated or uncoated. Those having ordinary skill in the machining arts are familiar with the various cemented carbides and may readily determine their suitability for use in rotary burrs constructed according to the present disclosure. Coatings providing improved wear resistance and/or other desirable characteristics may be applied to the substrate by conventional coating techniques including, for example, chemical vapor deposition (CVD), physical vapor deposition (PVD), or diamond coating techniques.

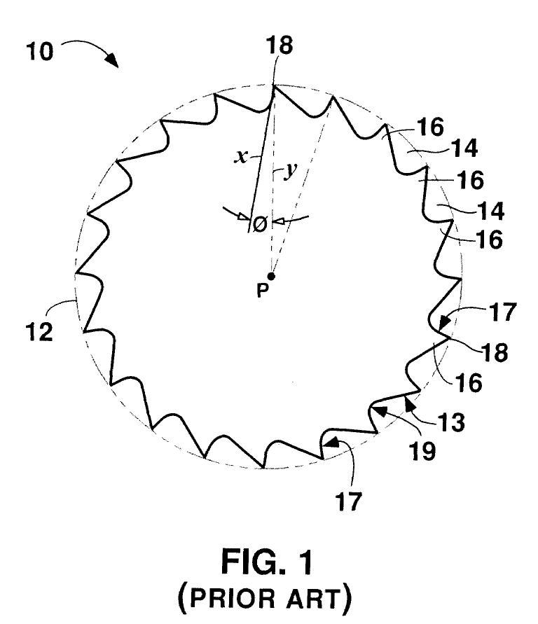

Aspects of embodiments of rotary burrs constructed according to the present disclosure will be understood by comparing such tools with FIG. 1, which is a schematic cross-sectional view approximately mid-way along the length of the working portion and at a right angle to the rotational axis of an embodiment 10 of a conventional cemented carbide rotary burr. As used herein, the “working portion” of a rotary burr is the region of the tool that has been ground or otherwise machined to include the cutting teeth. The working portion may also be referred to as, for example, the “burr head” of the tool. Dotted line 12 indicates the original periphery of the tool blank which has been ground at one end to form the working portion of the rotary burr 10. The rotational axis of rotary burr 10 is indicated as point P, and the tool further includes flutes 14 defining teeth 16. Each tooth 16 includes a front face 17, a tip 18, and a back face 13, which leads into an arc 19 transitioning to the next front face 17 of an adjacent tooth. It will be understood that the cross-section shown in FIG. 1 shows a section through the individual teeth 16, which run for a distance along a surface of the working portion of the rotary burr 10 and are present as “ridges” defined between adjacent right-handed helically oriented flutes 14.

With further reference to FIG. 1, each tooth 16 has a profile that includes a front face angle. As defined herein, the front face angle of a tooth may be assessed by considering a cross section through the tooth taken perpendicular to the axis of rotation of the tool, and is the angle between a first line drawn in the plane of the cross-section starting at the tooth tip and passing along the tooth's front face, and a second line drawn in the plane of the cross-section connecting the tooth tip and the rotational axis P. With specific reference to FIG. 1, the front face angle is the angle Ø between lines X and Y. If the front face angle is, as shown in the prior art embodiment of FIG. 1, less than zero (i.e., the direction of rotation about the tooth tip in the plane of the cross-section from line X to line Y is counterclockwise), then the tooth profile is considered to have a “negative” front face angle and, therefore, a “negative” front face geometry. According to the present disclosure, in addition to including a negative front face angle, a significant feature of the conventional rotary burr design shown in FIG. 1 is that it lacks lands at the periphery 12 of the working portion. Instead, each tooth 16 includes a tip 18 that is either sharp (i.e., ends in a point) or rounded to have a small radius. The small radius of a rounded tip may result from an edge treatment or honing applied to the tips, or may simply be the result of manufacturing tolerances associated with the process of forming the teeth on the working portion.

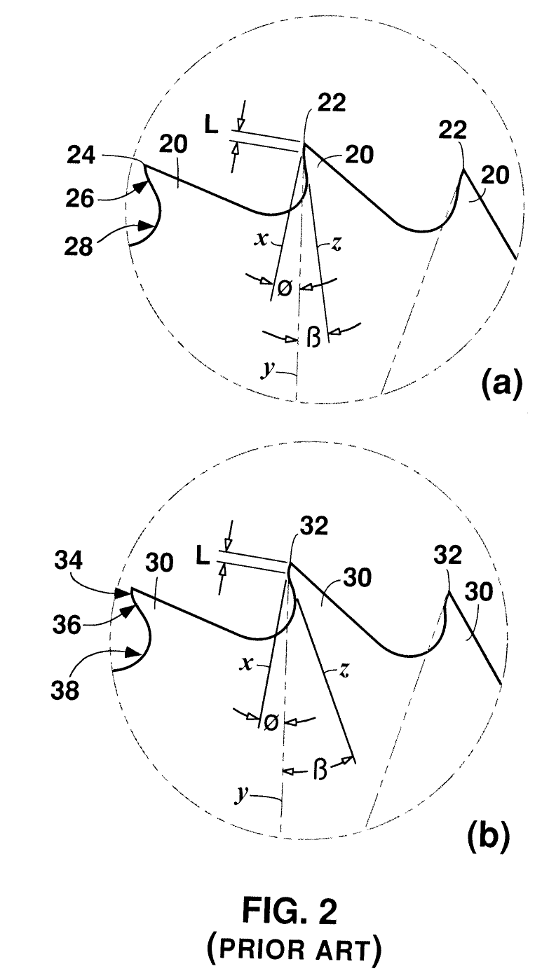

FIGS. 2(a) and 2(b) are schematic depictions of tooth profiles of additional embodiments of conventional cemented carbide rotary burrs. Referring to FIG. 2(a), teeth 20 have a negative front face angle Ø, which is defined as the negative angle between line X and line Y. Line X is drawn in the plane of the cross-section from the tooth tip 22 and along the first surface 24 of the tooth 20. Line Y (dotted) is drawn in the plane of the cross-section between tooth tip 22 and the rotational axis of the tool (not shown). This first surface 24 along which line X is drawn has a length L, as shown in FIG. 2(a). Although the front face of each tooth 20 also has a second surface 26 that leads into an arc 28, the line X drawn to determine the front face angle is drawn along the first surface 24 because this region of each tooth 20 determines the sharpness of the cutting edge and dictates the cutting effect of the tool into the workpiece during de-burring or other finishing operations. Thus, the front face angle of tooth 20 is the negative angle Ø in FIG. 2(a). This is the case even though, as shown in FIG. 2(a), the angle between line Z, which is a line drawn from the starting point of and along the second surface 26, and line Y is a positive angle β (i.e., the direction from line Z to line Y is clockwise).

FIG. 2(b) shows another conventional rotary burr tooth profile having a negative front face angle. Front face angle Ø in FIG. 2(b) is the negative angle between lines X and Y. Line X is drawn in the plane of the cross-section from the tooth tip 32 and along the first surface 34 of the tooth 30. Line Y (dotted) is drawn in the plane of the cross-section between tooth tip 32 and the rotational axis of the tool (not shown). The first surface 34 has a length L, as shown in FIG. 2(b). In addition to the first surface 34, the front face of each tooth 30 also includes a first arc 36, which follows after the first surface 34 and leads into a second arc 38. The front face angle of tooth 30 is the negative angle Ø even though, as shown in FIG. 2(b), an angle between line Z (a line drawn from the start point of the first arc 36 and along the tangent line of the first arc 36), and line Y is a positive angle β. Given the tangential orientation of the first arc 36, the positive angle β shown in FIG. 2(b) is greater than positive angle β shown in FIG. 2(a).

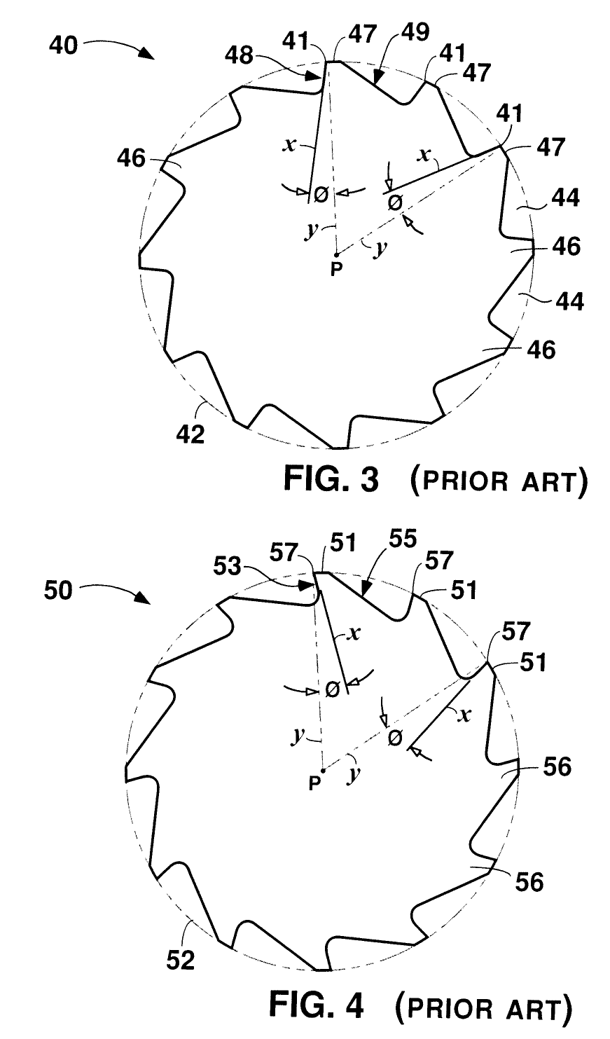

FIG. 3 is a schematic cross-sectional view approximately mid-way along the working portion and at a right angle to the rotational axis of another conventional cemented carbide rotary burr embodiment 40 showing the profile of teeth 46, defined by flutes 44, about the circumference of the rotary burr 40. Dotted line 42 is the original periphery of the blank from which the rotary burr 40 was ground. Each tooth 46 depicted about the cross-section of burr 40 includes a tip 41, a radial land 47 between the tooth front face 48 and the tooth back face 49, and each radial land 47 approximates the original periphery 42 of the cylindrical blank from which the tool was ground. Using lines Y drawn from the cylindrical axis P to adjacent tooth tips 41 and lines X drawn from a tooth tip 41 and along the surface of the front face 48, it will be seen that the front face angle Ø of each tooth is a negative angle as the rotational direction from line X to line Y for a particular tooth is counterclockwise. It has been observed that a limitation of a cemented carbide rotary burr having radial lands about the periphery of the working portion is that severe friction between the lands and the workpiece significantly increases the force necessary to de-burr or otherwise remove material from articles of difficult-to-machine materials.

FIG. 4 is a schematic cross-sectional view approximately mid-way through the working portion and at a right angle to the rotational axis of another embodiment 50 of a conventional cemented carbide rotary burr including radial lands 51 about original periphery 52 of the blank from which the tool was ground. The lands 51 are adjacent tooth tips 57 and between the front face 53 and back face 55 of each tooth 56. Using lines Y drawn from the cylindrical axis P to adjacent tooth tips 57, and lines X drawn from the tooth tips 57 and along the surface of the front face 53, it will be seen that the front face angle Ø of each tooth 56 is a positive angle as the rotational direction from line X to line Y for a particular tooth is clockwise. Although the rotary burr 50 has a positive front face angle Ø, it is believed that the tool still could not be used to effectively de-burr difficult-to-machine materials as a result of the substantial friction that would be generated between the radial lands 51 and the workpiece. Instead, in applications involving workpieces of titanium, titanium alloys, certain high-temperature alloys, various exotic alloys, or other difficult-to-machine materials, the workpiece will dominate the forces generated during a de-burring operation.

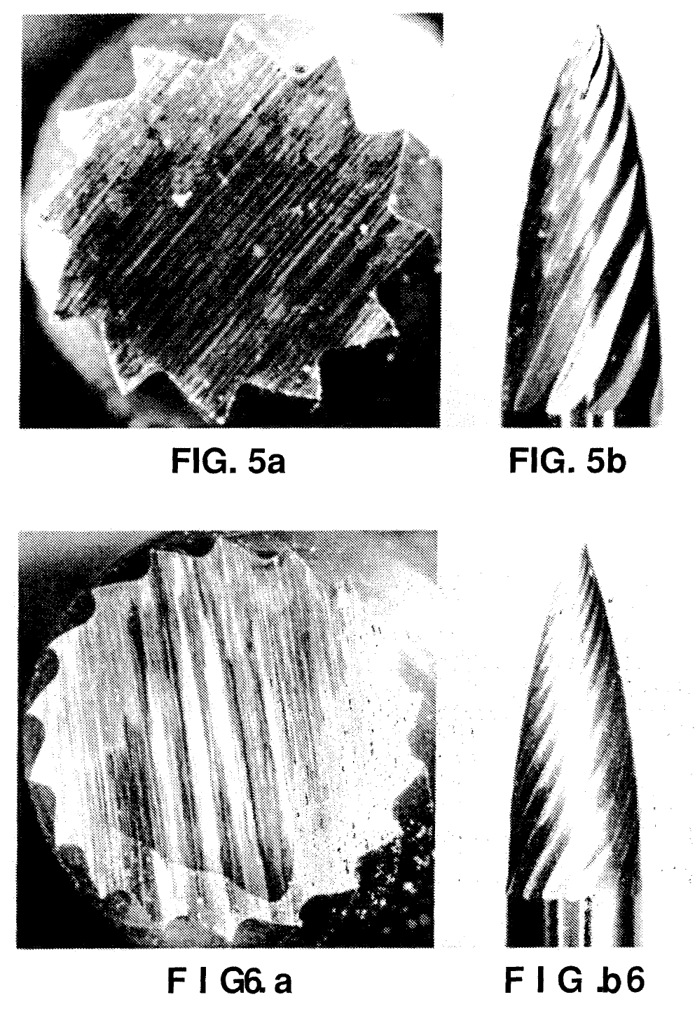

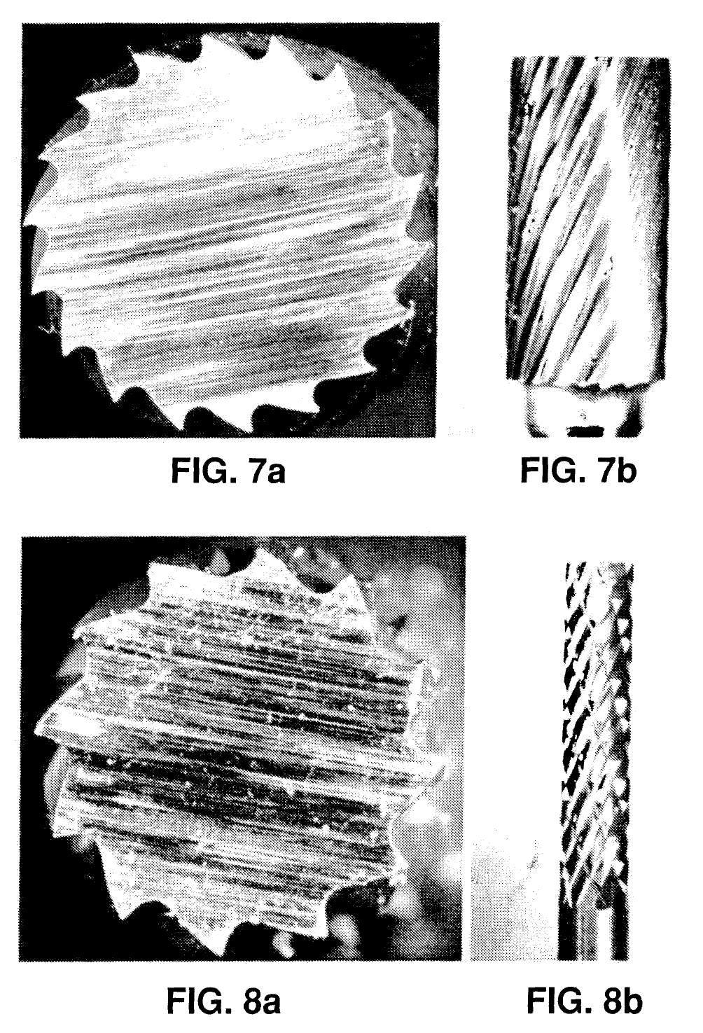

Aware of the long standing need to develop a rotary burr design that may be used to efficiently and cost-effectively de-burr difficult-to-machine materials, the present inventors studied the tooth profiles of various commercially available cemented carbide rotary burrs. Various examples of these commercially available rotary burrs are shown in FIGS. 5 through 9. Each of these figures includes photographs of (a) an end view of a cross-section through a mid-point of the working portion of the tool, wherein the section was taken at an approximately right angle to the tool's axis of rotation, and (b) a side elevational view of the working portion of the tool. FIGS. 5(a) and 5(b) show a commercially available cemented carbide rotary burr having a working portion with a generally “tree-shaped” profile and that is 6.35 mm in length and has a maximum diameter of 3.18 mm. FIGS. 6(a) and 6(b) show another commercially available cemented carbide rotary burr, also having a working portion with a generally “tree-shaped” profile, and wherein the working portion is 15.88 mm in length and has a maximum diameter of 6.35 mm. FIGS. 7(a) and 7(b) show yet another commercially available cemented carbide rotary burr, having a generally cylindrical working portion which is 12.27 mm in length with a diameter of 6.35 mm. FIGS. 8(a) and 8(b) show yet another commercially available cemented carbide rotary burr having a generally cylindrical working portion that is 14.29 mm in length and with a diameter of 3.18 mm, and wherein a series of flutes having a left-handed helical orientation crosses over a series of flutes having a right-handed helical orientation to produce a cross-hatched pattern defining discrete cutting teeth there between. The present inventors observed that each of the foregoing commercially available rotary burrs includes a series of right-handed flutes defining a working portion tooth profile having either (1) a positive front face angle and including radial lands about the periphery of the working portion; or (2) a negative front face angle and lacking radial lands.

The present inventors investigated alternative rotary burr designs not represented by the foregoing commercially available rotary burrs, and they evaluated whether the alternative designs significantly improve the capability of the tools to machine difficult-to-machine materials. Based on this investigation, the present inventors unexpectedly discovered that a unique rotary burr design, which includes teeth having a positive front face angle and lacking radial lands adjacent the tooth tips and disposed at the periphery of the working portion, can be used to very efficiently and cost-effectively de-burr titanium, titanium alloys, certain high-temperature alloys, and other difficult-to-machine materials. The inventors believe that rotary burrs with such a design are not and have not been commercially available or otherwise known. The present inventors determined that, in contrast to the unique designs described herein, commercially available rotary burr designs having a positive front face angle and including radial lands adjacent the tooth tips and at or near original periphery of the working portion can only be used effectively when de-burring or otherwise finishing non-ferrous materials and other materials that are not conventionally considered to be difficult to machine.

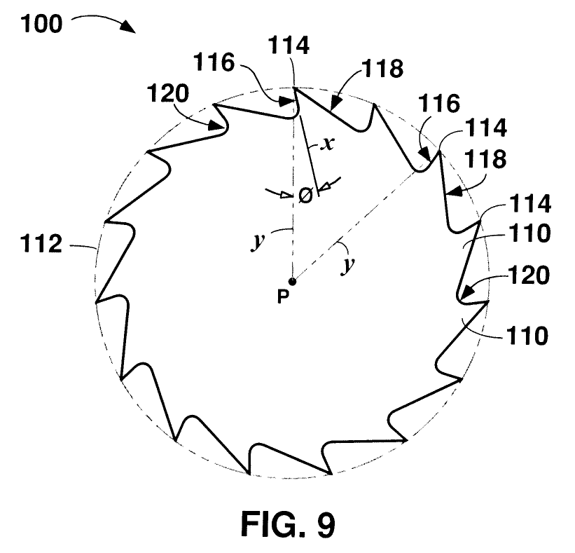

FIG. 9 schematically depicts a cross-sectional view approximately mid-way through the working portion of one non-limiting embodiment of a rotary burr 100 constructed according to the present disclosure, including teeth 110 having a positive front face angle without radial lands adjacent the tooth tips and at periphery of the working portion of the rotary burr 100. The rotary burr 100 may be constructed from, for example, cemented carbide. The tip 114 of each tooth 110 either has a sharp profile (as shown in FIG. 9) or is rounded with a relatively small radius. Dotted line 112 is the original cylindrical periphery of the cemented carbide blank from which the rotary burr 100 was ground. Each tooth 110 includes front face 116 and back face 118. Each tooth back face 118 terminates in arc 120 at the bottom of the tooth 110 and transitions into adjacent tooth 110. The front face angle ø is the positive angle between line Y, drawn in the plane of the cross-section between tooth tip 114 and cylindrical axis P, and line X, drawn in the plane of the cross-section from the tooth tip 114 and along the plane of the front face 116. The front face angle ø is positive because the rotational direction from line X to line Y for a particular tooth is clockwise.

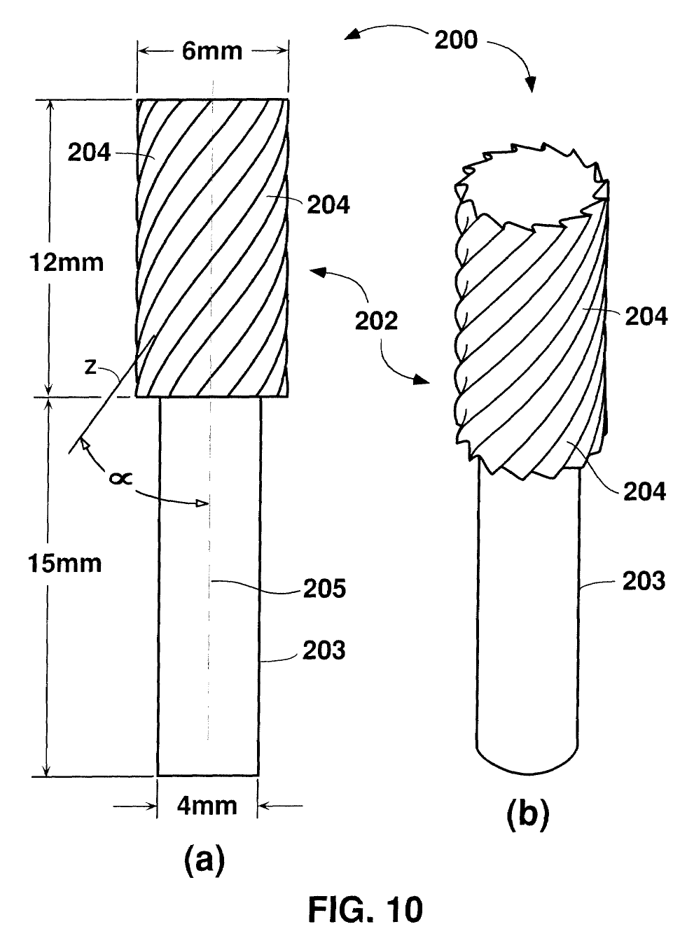

The geometry, size, shape, composition, and intended application of a rotary burr constructed according to the present disclosure may vary. FIGS. 10(a) and 10(b), for example, schematically depict another non-limiting embodiment of a rotary burr 200 constructed according to the present disclosure, having a generally cylindrical working portion 202 and a shank 203 for connecting the rotary burr 200 to a tool. In certain embodiments, rotary burr 200 may be manufactured from a one-piece, solid cemented carbide blank. Alternatively, rotary burr 200 may be manufactured in two parts, wherein the working portion 202 is made from a first cemented carbide and the shank 203 is made from a second cemented carbide, a metal, or a metallic alloy and is joined or otherwise connected to the working portion 202. In certain embodiments, for example, the shank may be made from a tungsten alloy or a steel, and is joined to the working portion 202 by brazing.

A surface of the working portion 202 of rotary burr 200 includes a series of right-handed helically oriented flutes 204 that may be uniformly or non-uniformly distributed about the surface. As used herein, a “right-handed” orientation means that the flute passes from left to right along the working portion as one moves along the flute from the bottom to the top of the working portion. A “left-handed” orientation means that the flute passes from right to left along the working portion as one moves along the flute from the bottom to the top of the working portion. In either case, the “bottom” and “top” of the working portion are determined with reference to an elevational orientation of the tool, such as, for example, the elevational orientation shown in FIG. 10(a), with the “bottom” proximal and the “top” distal relative to the shank. The flutes 204 may have identical or non-identical geometries. The working portion 202 of rotary burr 200 has a diameter of 6 mm and a length of 12 mm, and the shank 203 has a diameter of 4 mm and a length of 15 mm. Burr 200 has a flute angle of about 38 degrees, which is the angle α defined between a line Z in the direction of the flutes 204 and the rotational axis 205 of the rotary burr 200.

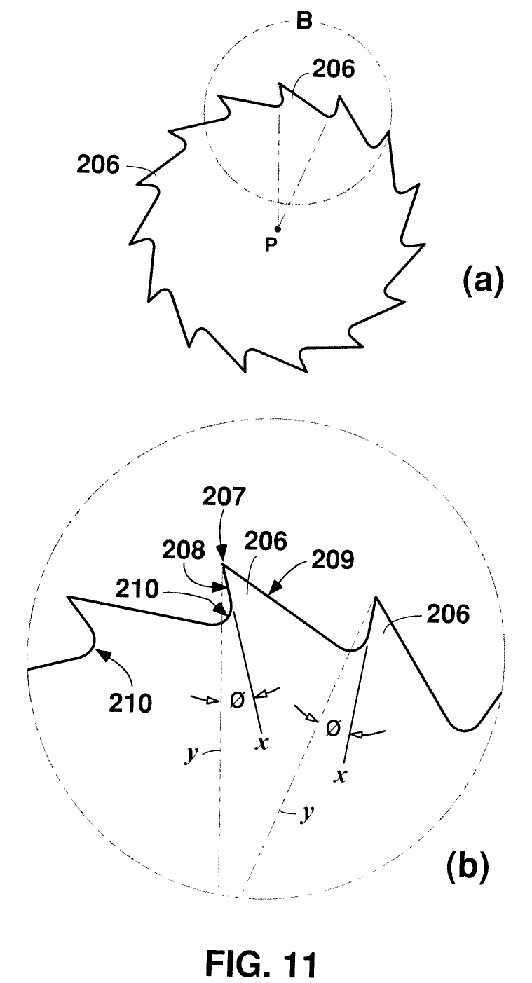

FIG. 11(a) is a cross-section through the working portion 202 of rotary burr 200 of FIGS. 10(a) and (b) taken at line C-C in FIG. 10(a), wherein P is the point of the rotational axis and teeth 206 are revealed as sections through flutes 204. Circular portion B of the cross-section shown in FIG. 11(a) is shown in magnified detail in FIG. 11(b). Each tooth 206 includes tip 207, front face 208, back (flank) face 209, and arc portion 210, which leads into the back face 209 of the adjacent tooth 206. The tip 207 may be a sharp point or a rounded nose with a small radius, and the teeth 206 lack radial lands adjacent the tooth tip 207. As explained above, the front face angle of a tooth is the angle between a first line drawn from the tooth tip and along the surface of the front face, and a second line drawn between the tooth tip and the point of the cylindrical axis. In FIG. 11(b), the front face angle of tooth 206 is the angle between line X, drawn from the tooth tip 207 and along the front face 208 of the tooth 206, and line Y, drawn between the point P marking the cylindrical axis (see FIG. 11(a)) and the tooth tip 207. Front face angle ø in FIG. 11(b) is approximately 10 degrees and is a positive angle. The radius of the arc 210, which also may be referred to as the tooth bottom radius, is approximately 0.15 mm.

FIGS. 12(a) and 12(b) schematically depict an additional embodiment of a rotary burr 300 comprising cemented carbide and constructed according to the present disclosure. Burr 300 includes a generally cylindrical working portion 302 and a shank 303. The surface of the working portion 302 includes a series of right-handed helically oriented flutes 304 that may be uniformly or non-uniformly distributed about the surface, and may have identical or non-identical geometries. The working portion 302 of burr 300 has a diameter of 6 mm and a length of 8 mm, and shank 303 has a diameter of 4 mm and a length of 15 mm. Burr 300 has a flute angle α of about 8 degrees, defined between a line Z in the direction of the flutes 304 and the cylindrical axis 305 of the rotary burr 300. Thus, the length of the working portion and the flute angle of rotary burr 300 are each less than those in burr 200. According to the present disclosure, the teeth of rotary burr 300 have a positive front face angle and lack radial lands adjacent the tooth tips and at the periphery of the working portion.

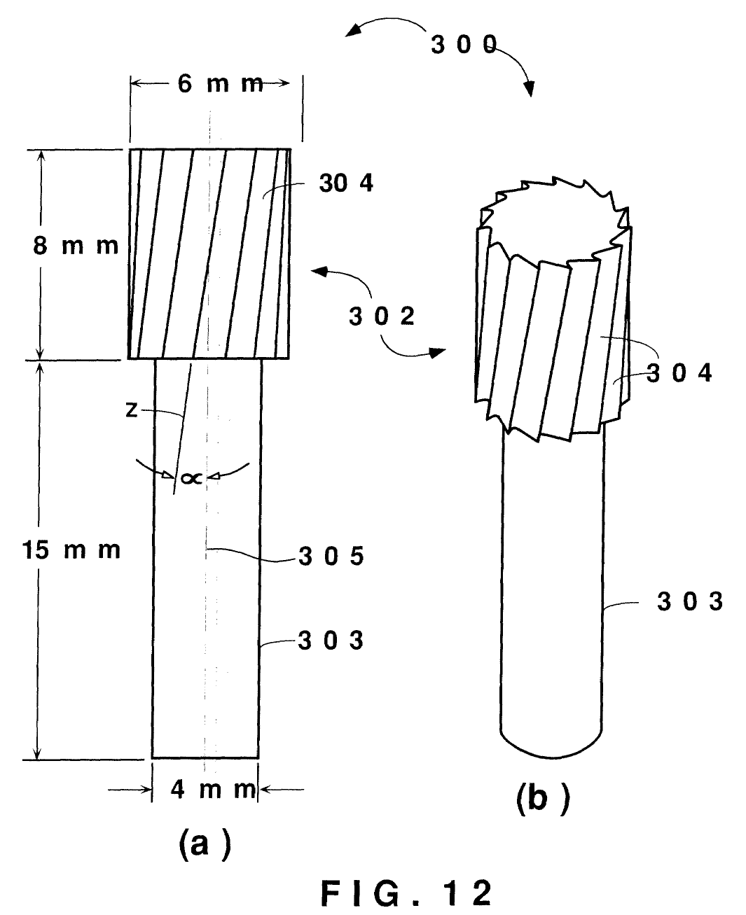

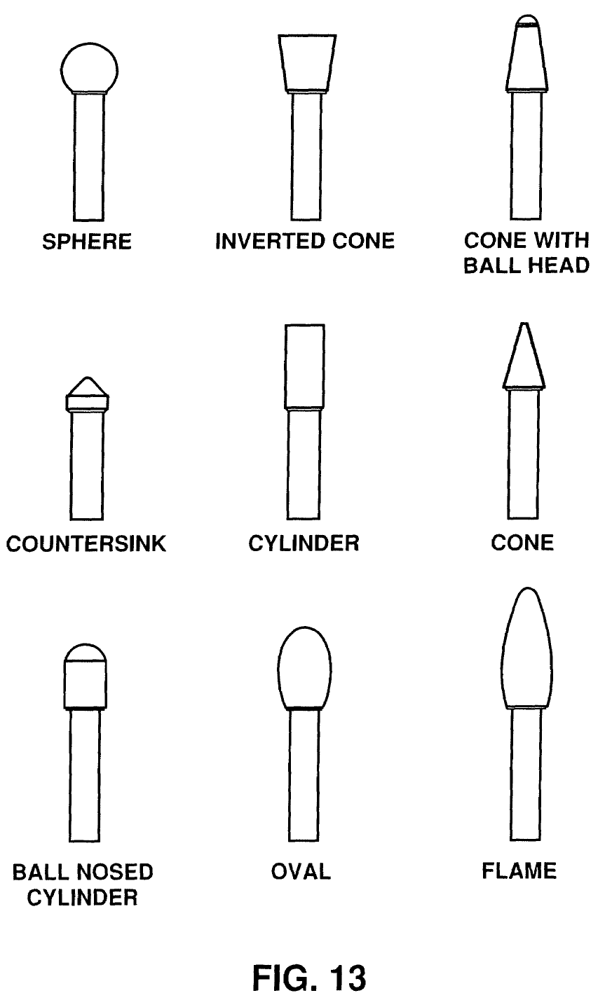

Rotary burrs comprising cemented carbide and constructed according to the present disclosure may have any of the various working portion configurations used in rotary burrs. FIG. 13 shows several possible non-limiting examples of working portion configurations for rotary burrs constructed according to the present disclosure. The depicted working portion configurations are a sphere, an inverted cone, a cone with a ball head, a countersink, a cylinder, a cone, a ball-nosed cylinder, an oval, a tree styled configuration, and a flame-shaped configuration. Possible additional working portion configurations for rotary burrs will be familiar to those having ordinary skill in the machining arts. In embodiments constructed according to the present disclosure, however, the teeth of the working portion of the rotary burr have a positive front face angle and lack radial lands adjacent the tooth tips and disposed at the periphery of the working portion. It will be understood that the working portion configuration of a rotary burr constructed according to the present disclosure is not limited to those configurations shown in FIG. 13, but instead may have any known or developed working portion configuration.

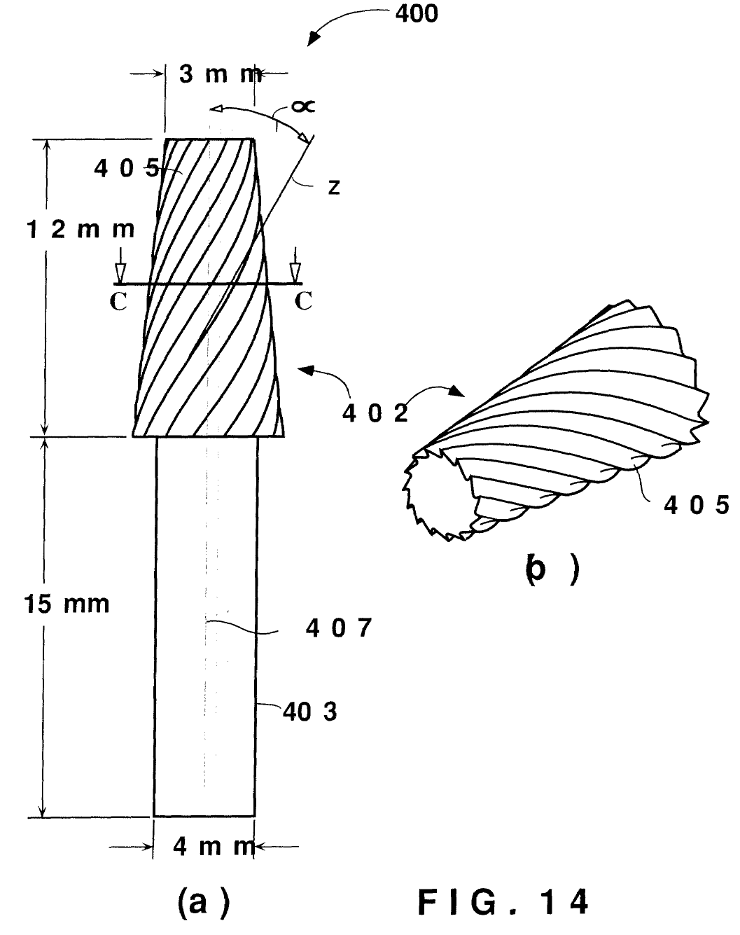

FIGS. 14(a) through 14(c) depict views of yet another embodiment of a rotary burr comprising cemented carbide and constructed according to the present disclosure and having a generally cone-shaped working portion. FIG. 14(a) is a schematic side elevational view of the rotary burr 400, which generally includes working portion 402 and shank 403. Flutes 405 are helically disposed about the surface of the working portion 402. FIG. 14(b) is a perspective view of the working portion 402 of rotary burr 400. FIG. 14(c) is a schematic cross-sectional view through the working portion 402 at line C-C, exposing the individual tooth profiles, and showing in dotted lines the cylindrical periphery 404 encompassing the tooth tips at the widest region of the working portion 402. According to one specific non-limiting embodiment, the minimum diameter of working portion 402 is 3 mm, the length of working portion is 12 mm, the diameter of shank 403 is 4 mm, and the length of shank 403 is 15 mm. Burr 400 has a flute angle α of about 8 degrees, which is the angle between a line Z in the direction of the flutes 405 and the rotational axis 407 of the rotary burr 400. As shown in FIG. 14(c), each tooth 405 has a positive front face angle and lacks a radial land adjacent the tooth tip about the conical periphery of the working portion.

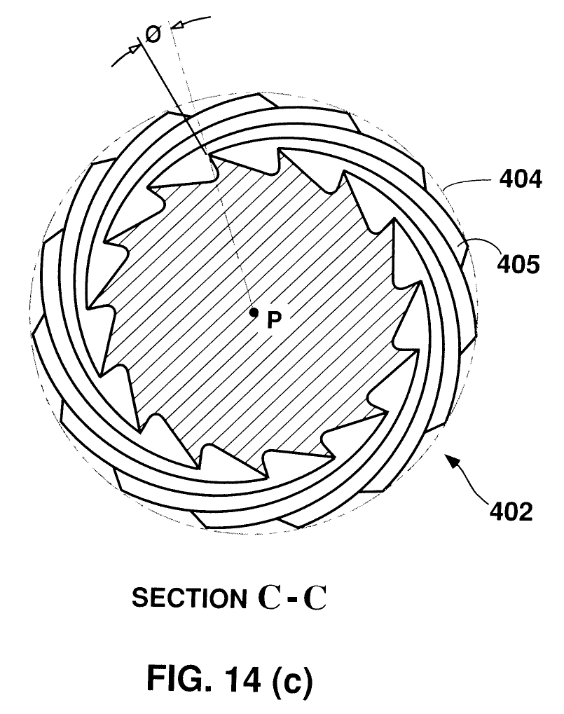

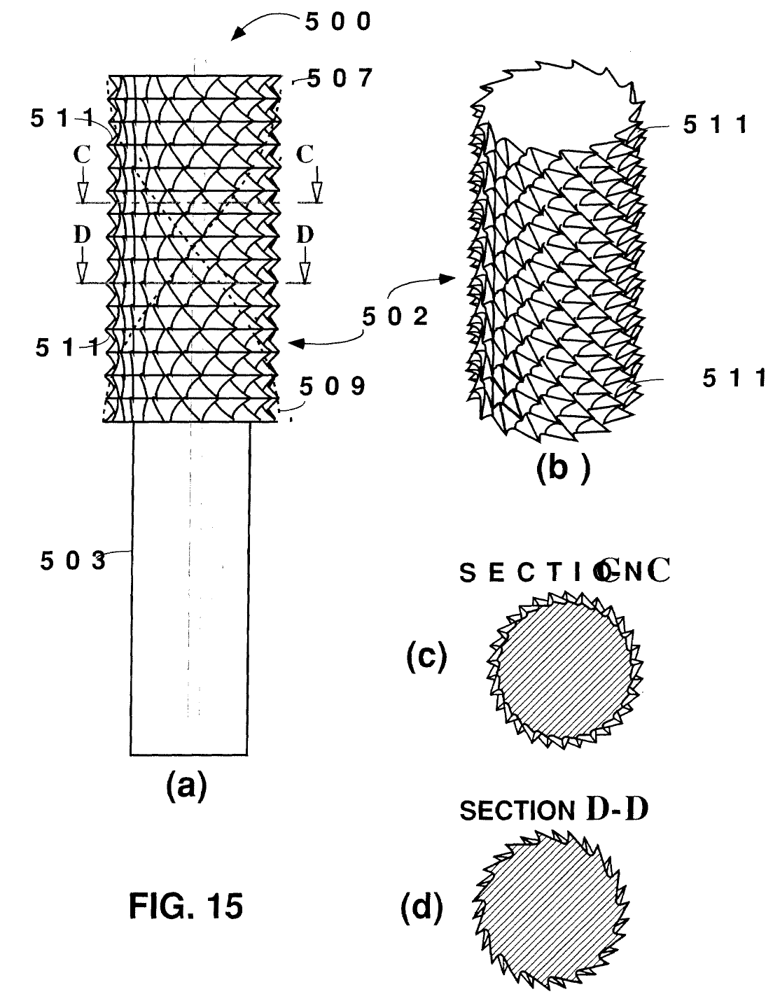

According to certain non-limiting embodiments of a rotary burr constructed according to the present disclosure, the working portion may include generally helically-oriented flutes crossing in both left and right directions. A rotary burr including left-hand helically oriented flutes crossing over right-hand helically oriented flutes to provide a cross-fluted pattern may improve the chip breaking performance of the rotary burr, but also may result in a coarser surface finish on the machined workpiece. The additional left-hand cross flutes may be of any tooth profile including, for example, profiles having a positive front face or a negative front face. Additionally, the additional left-hand helically oriented cross flutes may have flute parameters and/or a tooth geometry that differ from the right-hand helically oriented flutes. FIGS. 15(a) through 15(d) schematically depict one such non-limiting embodiment. FIG. 15(a) is a schematic side elevational view of rotary burr 500 comprising cemented carbide, which generally includes cylindrical working portion 502 and shank 503. FIG. 15(b) is a perspective view of the working portion 502 of rotary burr 500. FIG. 15(c) and FIG. 15(d) are schematic cross-sectional views through the working portion 502 at lines C-C and D-D, respectively, exposing the individual tooth profiles at those sections. Dotted line 507 follows the helical path of a right-hand flute, and dotted line 509 follows the helical path of a left-hand flute. The series of right-hand flutes and series of left-hand flutes disposed about the surface of the working portion 502 cross to create a cross-hatched design that defines multiple discrete solid cutting teeth 511 bounded by the crossing flutes. According to the present disclosure, the tooth profiles shown in the cross-sections C-C (FIG. 5(c)) and D-D (FIG. 5(d)) have a positive front face angle and lack a radial land adjacent the tooth tips and disposed at the cylindrical periphery of the working portion 502.

Certain non-limiting embodiments of a rotary burr having a positive front face angle and lacking radial lands adjacent the tooth tips and at the periphery of the working portion according to the present disclosure also may include a series of chip breakers added to the tooth profiles defined by the flutes. The chip breakers may have the same or differing configurations. The chip breakers may be provided to promote the chip breaking process and thereby improve process control. FIGS. 16(a) through 16(d), for example, schematically depict one such non-limiting embodiment of a rotary burr 600 including working portion 602 and shank 603 constructed according to the present disclosure, and including chip breakers 604 spaced along flutes 605. FIG. 16(b) is a perspective view of the working portion 602 of rotary burr 600. FIG. 16(c) and FIG. 16(d) are schematic cross-sectional views through the working portion 602 at lines C-C and D-D (in the directions of the arrows), respectively, exposing the individual tooth profiles and the intersected chip breaking geometries at those sections. According to the present disclosure, the tooth profiles shown in the cross-sections C-C (FIG. 16(c)) and D-D (FIG. 16(d)) have a positive front face angle and lack radial lands adjacent the tooth tips and disposed at the cylindrical periphery of the working portion 602.

Certain embodiments of a rotary burr constructed according to the present disclosure may be designed with two or more regions including differing materials, which may be cemented carbides or other materials. For example, the two or more regions may include cemented carbides that differ in composition or that may be different grades of the same cemented carbide composition. For example, two grades may have the same composition, but differ in terms of grain size and/or other microstructural characteristics. The cemented carbides included in the different regions may be selected to provide properties desirable in the particular regions in which the materials are incorporated.

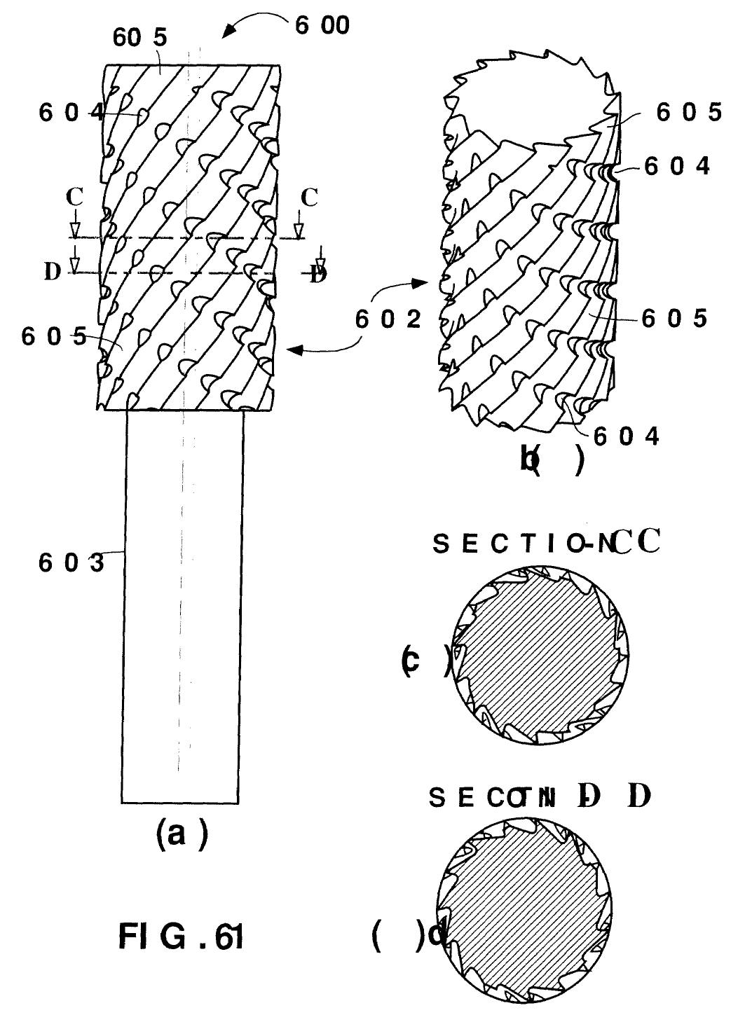

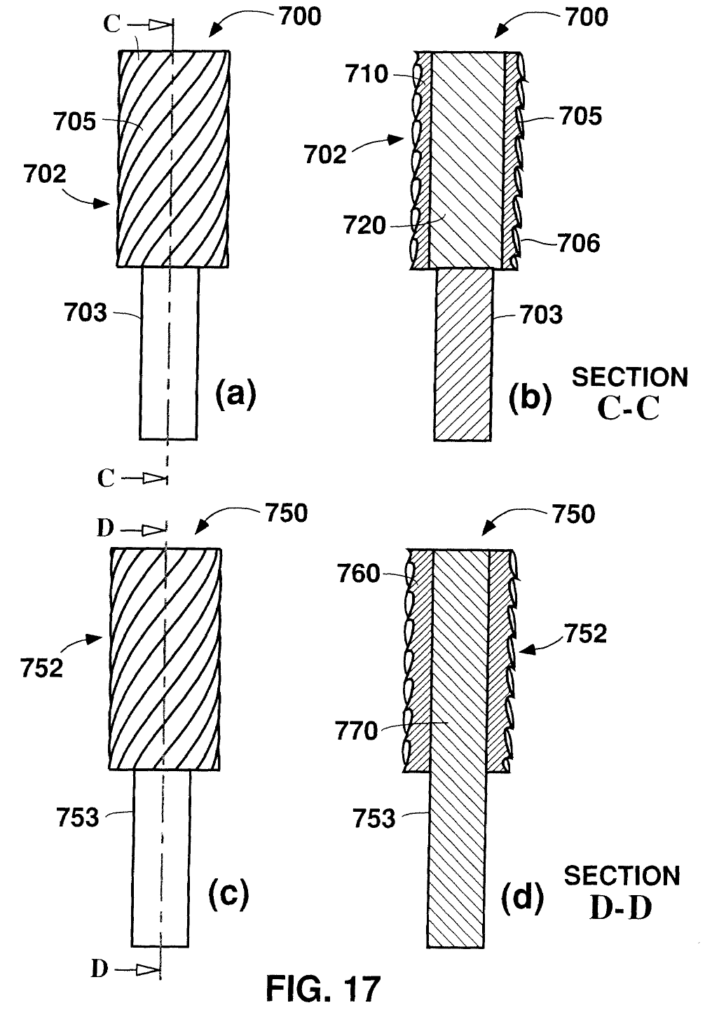

Certain non-limiting examples of rotary burrs constructed according to the present disclosure and including regions comprising different materials are schematically depicted in FIGS. 17(a) through 17(d). FIG. 17(a) schematically illustrates an elevational view of one non-limiting embodiment of a rotary burr 700 constructed in this manner, and which includes working portion 702 and shank 703. FIG. 17(b) depicts a cross-sectional view through longitudinal axis C-C of rotary burr 700. An outer region 710 of the working portion 705, which includes flutes 706, is composed of a first cemented carbide having substantial toughness. A core region 720 of the working portion 702 is composed of a second cemented carbide material having increased strength relative to the first cemented carbide. Shank 703 constitutes a third region that may be made from a material that differs from the materials in the first and second regions. For example, shank 703 may be formed from steel or a tungsten alloy, and is joined (such as by brazing) or is otherwise connected to the working portion 702. According to the present disclosure, the teeth of the working portion 702 of rotary burr 700 have a positive front face angle and lack radial lands adjacent the tooth tips and at the cylindrical periphery of the working portion 702.

FIG. 17(c) schematically illustrates an elevational view of another non-limiting embodiment of a rotary burr 750 constructed according to the present disclosure, designed with multiple regions composed of different materials. FIG. 17(d) depicts a cross-sectional view through longitudinal axis D-D of burr 750. The working portion 752 is a composite of an outer layer 760 composed of a first cemented carbide material, and a region of a second cemented carbide material from which the inner core 770 of the working portion 752 and the shank 753 are constructed. The working portion 752 is a composite of an outer layer 760 composed of a first cemented carbide material, and a region of a second cemented carbide material from which the inner core 770 of the working portion 752 and the shank 753 are constructed. In certain embodiments the first cemented carbide material may be a grade having substantial toughness, and the second cemented carbide material may be a grade having increased strength relative to the first grade. The teeth of the working portion 752 of burr 750 have a positive front face angle and lack radial lands adjacent the tooth tips at the cylindrical periphery of the working portion 752.

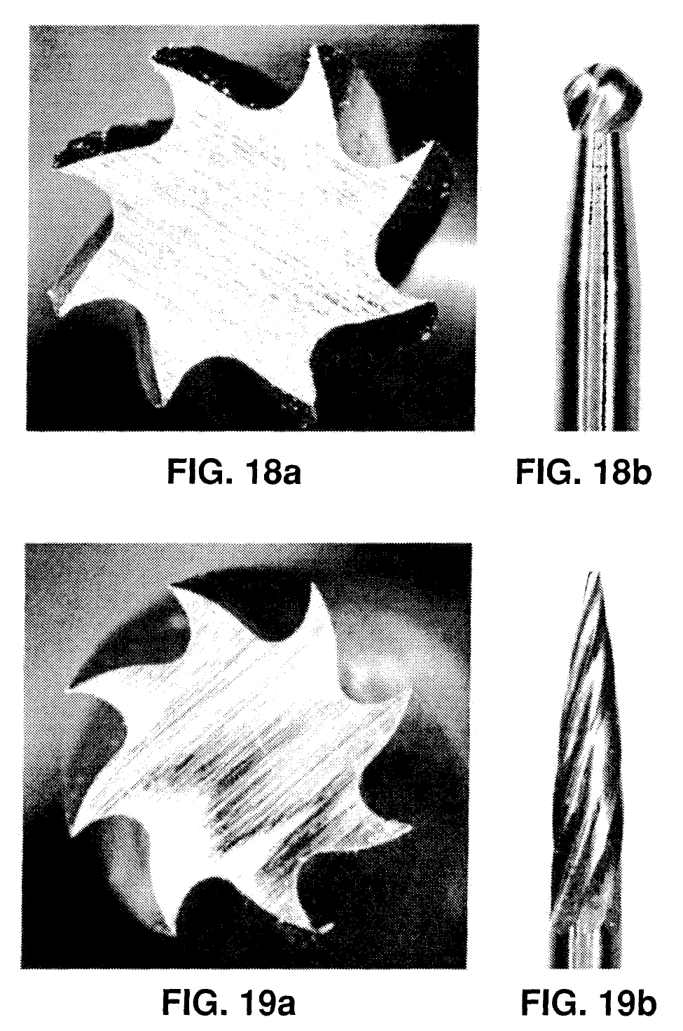

FIGS. 18 and 19 are photographs of two non-limiting embodiments of rotary burrs comprising cemented carbide and constructed according to the present disclosure. FIG. 18(a) is an elevational view of an embodiment having a sphere-shaped working portion with a diameter of 3 mm and a length of 2.69 mm. FIG. 18(b) is a photograph of a cross-section taken through the working portion of the rotary burr shown in FIG. 18(a), wherein the cross-section is taken at a right angle to the axis of rotation of the rotary burr. FIG. 19(a) is an elevational view of an embodiment having a generally “tree-shaped” working portion with a maximum diameter of 3 mm and a length of 13 mm. FIG. 19(b) is a photograph of a cross-section taken through the working portion of the rotary burr shown in FIG. 19(a), wherein the cross-section is taken at a right angle to the axis of rotation of the rotary burr. In each of the rotary burrs shown in FIGS. 18 and 19, the teeth of the working portion have a positive front face angle of about 6 degrees and do not include radial lands adjacent the tooth tips at the periphery of the working portion.

Embodiments of rotary burrs constructed according to the present disclosure may be made using conventional techniques for manufacturing rotary burrs. As an example, a method of making a rotary burr according to the present disclosure includes grinding and/or machining a cemented carbide blank to provide a series of right-handed helically oriented flutes on at least a portion of the blank. The portion of the blank including the flutes forms the working portion of the rotary burr. Non-limiting examples of possible shapes of the working portion include a cylinder, a sphere, a cone, an inverted cone, a cone with a ball head, a countersink, an oval, a flame, a tree shape, and a ball-nosed cylinder. In certain embodiments of the method, another portion of the blank may form the shank of the rotary burr. Regions disposed between adjacent flutes are processed, such as by machining, to provide a series of cutting teeth on the working portion. According to unique aspects provided in the present disclosure, each cutting tooth is machined to have a positive front face angle, and each tooth lacks a radial land at the periphery of the working portion.

According to one non-limiting embodiment of the method, the blank includes a first region composed of a first material and a second region composed of a second material, wherein a composition of the first material differs from a composition of the second material. In one non-limiting embodiment, the first material and the second material are both cemented carbides. In one non-limiting embodiment of the method, the first region forms at least a portion of an outer region of the working portion of the rotary burr, and the second region forms at least a portion of a core region of the working portion and a shank of the rotary burr. In one non-limiting embodiment of the method, the blank forms at least the working portion of the rotary burr, and the method further includes joining a shank to the working portion. Also, one non-limiting embodiment of the method includes providing a series of left-handed helically oriented flutes on the working portion that intersect the plurality of right-handed helically oriented flutes to thereby define a plurality of discrete cutting teeth. An additional non-limiting embodiment of the method includes applying a surface coating to at least a portion of the rotary burr, and the surface coating may be, for example, one of a chemical vapor deposition (CVD) coating, a physical vapor deposition (PVD) coating, and a diamond coating.

Persons having ordinary skill, after reviewing the present disclosure, will readily contemplate additional possible methods of making rotary burrs according to the present disclosure.

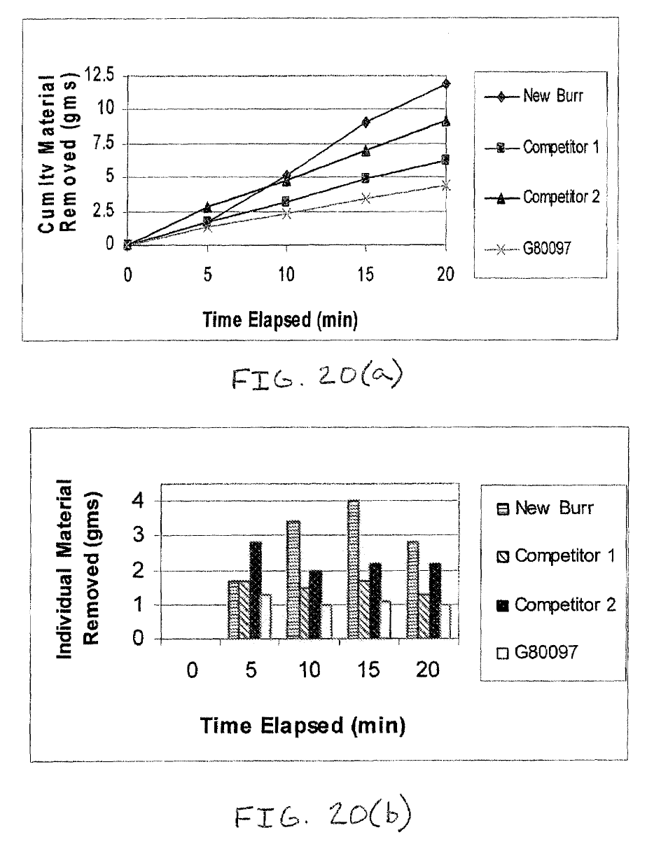

As discussed above, embodiments of rotary burrs constructed according to the present disclosure provide significant improvements in cutting performance. FIGS. 20(a) and 20(b) are graphs of test results comparing cutting performance of: (1) an embodiment of a cemented carbide rotary burr constructed according to the present disclosure including 8 flutes on the burr head (“new burr”); (2) a model no. G80097 rotary burr available from ATI Stellram, La Vergne, Tenn., including 12 flutes on the burr head (“G80097”); (3) a competitor's rotary burr including 10 flutes on the burr head (“competitor 1”); and (4) a competitor's rotary burr including 8 flutes on the burr head (“competitor 2”). Only the “new burr” embodiment included both a positive front face angle and lacked radial lands about the periphery of the burr head. Other than these noted differences, the four rotary burrs tested were substantially identical. The burrs were used to machine Ti-6Al-4V titanium alloy having hardness of 320HB at a tool rotational speed of 100,000 rpm under substantially identical operating conditions. Ti-6Al-4V alloy (UNS R56400) is a difficult-to-machine titanium alloy commonly used in applications including: turbine blades, discs, and rings; airframes; high performance fasteners, and biomedical implants.

FIG. 20(a) shows the cumulative mass of material removed by each rotary burr during the 20-minute test period. FIG. 20(b) shows the mass of material removed by each rotary burr during discrete 5-minute intervals of the 20-minute test period. The horizontal axis of FIG. 20(b) lists the end point of the particular 5-minute intervals. Thus “5” on the horizontal axis of FIG. 20(b) refers to the 5-minute interval ending at 5 minutes, “10” refers to the 5-minute interval beginning at 5 minutes and ending at 10 minutes, etc. It is evident from FIG. 20(a) that the rotary burr having the unique design according to the present disclosure removed substantially more of the titanium alloy in the 20-minute test period than the tested conventional rotary burrs. FIG. 20(b) shows that the advantages gained from the experimental rotary burr were evident in the latter portion of the 20-minute period. In each of the 5-minute periods ending at 10, 15, and 20 minutes, the experimental rotary burr removed significantly more of the titanium alloy than the conventional tools. Given the test parameters, the apparent advantages of the experimental rotary burr were a result of the unique tooth geometry that is a feature of embodiments according to the present disclosure.

Although the foregoing description has necessarily presented only a limited number of embodiments, those of ordinary skill in the relevant art will appreciate that various changes in the subject matter and other details of the examples that have been described and illustrated herein may be made by those skilled in the art, and all such modifications will remain within the principle and scope of the present disclosure as expressed herein and in the appended claims. For example, although the present disclosure has necessarily only presented a limited number of embodiments of rotary burrs constructed according to the present disclosure, it will be understood that the present disclosure and associated claims are not so limited. Those having ordinary skill will readily identify additional rotary burr designs and may design and build additional rotary burrs along the lines and within the spirit of the necessarily limited number of embodiments discussed herein. It is understood, therefore, that the present invention is not limited to the particular embodiments disclosed or incorporated herein, but is intended to cover modifications that are within the principle and scope of the invention, as defined by the claims. It will also be appreciated by those skilled in the art that changes could be made to the embodiments above without departing from the broad inventive concept thereof.

We claim:

1. A rotary burr comprising cemented carbide, the rotary burr further comprising:
a shank; and
a working portion, wherein a surface of said working portion comprises a plurality of right-handed helically oriented flutes defining a plurality of cutting teeth, wherein each of said cutting teeth comprises a front face, a back face, a tip, and a positive front face angle, and lacks a radial land disposed at a periphery of said working portion.

2. The rotary burr of claim 1, wherein the rotary burr comprises at least a first region of a first material and a second region of a second material, wherein a composition of said first material differs from a composition of said second material.

3. The rotary burr of claim 2, wherein said first material and said second material are cemented carbides.

4. The rotary burr of claim 3, wherein said first region comprises an outer region of said working portion, and wherein said second region comprises a core region of said working portion and said shank.

5. The rotary burr of claim 4, wherein said first material and said second material are cemented carbides.

6. The rotary burr of claim 2, wherein said first region comprises said working portion and said second region comprises said shank, and wherein said shank is joined to said working portion.

7. The rotary burr of claim 6, wherein said first material is a cemented carbide and said second material is one of a steel and a tungsten alloy.

8. The rotary burr of claim 1, wherein said working portion has a shape selected from a cylinder, a sphere, a cone, an inverted cone, a cone with a ball head, a countersink, an oval, a flame, a tree shape, and a ball-nosed cylinder.

9. The rotary burr of claim 1, wherein said surface of said working portion further comprises a plurality of left-handed helically oriented flutes intersecting said plurality of right-handed helically oriented flutes to thereby define a plurality of discrete cutting teeth.

10. The rotary burr of claim 1, wherein at least said working portion comprises a surface coating.

11. The rotary burr of claim 11, wherein said surface coating is one of a chemical vapor deposition (CVD) coating, a physical vapor deposition (PVD) coating, and a diamond coating.

12. A rotary burr comprising cemented carbide, the rotary burr further comprising:
a shank; and
a working portion, wherein said working portion comprises at least an outer region of a first cemented carbide, and wherein a surface of said outer region comprises a plurality of right-handed helically oriented flutes defining a plurality of cutting teeth, each of said cutting teeth comprising a front face, a back face, a tip, and a positive front face angle, and lacking a radial land disposed at a periphery of said working portion.

13. The rotary burr of claim 12, wherein said shank and at least a core region of said working portion comprise a second cemented carbide.

14. The rotary burr of claim 12, wherein said working portion comprises said first cemented carbide, and wherein said shank comprises one of a metal alloy, a steel, and a tungsten alloy and is joined to said working portion.

15. The rotary burr of claim 12, wherein said working portion comprises a surface coating.

16. The rotary burr of claim 15, wherein said surface coating is one of a chemical vapor deposition (CVD) coating, a physical vapor deposition (PVD) coating, and a diamond coating.

17. A method of making a rotary burr comprising cemented carbide, the rotary burr further comprising a working portion including a series of cutting teeth, the method comprising:
providing a series of right-handed helically oriented flutes on at least a portion of the blank to provide a working portion of the rotary burr; and
processing regions disposed between adjacent flutes to provide a series of cutting teeth on the working portion, each cutting tooth including a positive front face angle and lacking a radial land at a periphery of the working portion.

18. The method of claim 17, wherein the blank comprises a first region of a first material and a second region of a second material, wherein a composition of the first material differs from a composition of the second material.

19. The method of claim 18, wherein the first material and the second material are cemented carbides.

20. The method of claim 19, wherein the first region forms at least a portion of an outer region of the working portion, and wherein the second region forms at least a portion of a core region of the working portion and a shank of the rotary burr.

21. The method of claim 17, further comprising:
joining a shank to the working portion.

22. The method of claim 17, wherein the working portion has a shape selected from a cylinder, a sphere, a cone, an inverted cone, a cone with a ball head, a countersink, an oval, a flame, a tree shape, and a ball-nosed cylinder.

23. The method of claim 17, further comprising:
providing a series of left-handed helically oriented flutes on the portion of the blank intersected by the plurality of right-handed helically oriented flutes to thereby define a plurality of discrete cutting teeth.

24. The method of claim 17, further comprising:
applying a surface coating to at least a portion of the rotary burr.

25. The method of claim 24, wherein the surface coating is one of a chemical vapor deposition (CVD) coating, a physical vapor deposition (PVD) coating, and a diamond coating.
